(19) United States
(12) Patent Application Publication
(10) Pub. No.: US 2020/0001926 A1
(43) Pub. Date: Jan. 2, 2020

(54) BEARING PLATE FOR A VEHICLE BEARING

(71) Applicant: Dr. Ing. h.c. F. Porsche Aktiengesellschaft, Stuttgart (DE)

(72) Inventors: Philipp Berendes, Stuttgart (DE); Andreas Higle, Leonberg (DE); Bernhard Wiedemann, Stuttgart (DE)

(73) Assignee: Dr. Ing. h.c. F. Porsche Aktiengesellschaft, Stuttgart (DE)

(21) Appl. No.: 16/258,861

(22) Filed: Jan. 28, 2019

(30) Foreign Application Priority Data
Feb. 1, 2018 (DE) 102018102270.0

(51) Int. Cl. B62D 21/09; B62D 21/10; B62D 21/11; F16F 1/38

(52) U.S. Cl. CPC B62D 21/09; F16F 1/38; B62D 21/11; B62D 21/10

(57) ABSTRACT

A bearing plate for a chassis bearing of a vehicle, having a main body with a bearing section for making full-area contact with a complementary bearing face of a component to be mounted, and having a receiving section for being received in a force-transmitting manner on a complementary receiving section of a chassis component. The bearing section is connected to the receiving section via at least two spring sections which have a spring structure or a sprung relative movability in the radial direction and a stabilization in the axial direction.

### CROSS-REFERENCE TO RELATED APPLICATION

This application claims priority to German Patent Application No. DE 10 2018 102 270.0, filed Feb. 1, 2018, which is incorporated by reference herein in its entirety.

### FIELD OF THE INVENTION

The present invention relates to a bearing plate for a chassis bearing of a vehicle and to a bearing apparatus for a chassis bearing of a vehicle.

### BACKGROUND OF THE INVENTION

It is known that vehicles have chassis bearings, in order to mount link systems and wheel suspension systems correspondingly. Here, the main task of chassis bearings of this type is the dissipation of radial forces and a stabilization in the axial direction, that is to say against tilting about or with respect to the bearing axis of the respective chassis bearing. The known solutions mainly comprise elastomers which are used as resilient and damping components. They can be managed inexpensively, but have some disadvantages. One main disadvantage in the case of the use of elastomeric components for chassis bearings is the unavoidable wear thereof and their temperature dependence. In addition to the actual loading, the wear is increased by way of temperature fluctuations in the case of the use of elastomers. A further disadvantage is the relatively complex spring structure of elastomers of this type. Although they provide the desired spring elasticity in the radial direction, they also have secondary spring rates which permit suspension possibilities and therefore also relative movements in the other directions, in particular along the bearing axis. This can either be accepted or can be structurally limited or eliminated by way of complex measures.

### SUMMARY OF THE INVENTION

In view of the foregoing it would be desirable to simplify or to improve the bearing behavior of a chassis bearing in an inexpensive and simple way.

Features and details which are described in conjunction with the bearing plate according to aspects of the invention also apply in conjunction with the bearing apparatus according to aspects of the invention, and vice versa in each case, with the result that reference is always made or can always be made mutually to the individual aspects of the invention with regard to the disclosure.

According to aspects of the invention, a bearing plate is provided for a chassis bearing of a vehicle. A bearing plate of this type has a main body with a bearing section for making full-area contact with a complementary face of a component to be mounted. Furthermore, the main body is equipped with a receiving section for being received in a force-transmitting manner on a complementary receiving section of a chassis component. Here, the bearing section is connected to the receiving section via at least two spring sections which have spring structures for a sprung relative movement of the bearing section with respect to the receiving element in all spatial directions and about all spatial axes. The spring rates can be adjusted freely independently of one another by way of corresponding shaping and arranging of the spring structures.

Therefore, a bearing plate according to aspects of the invention then comprises spring sections with corresponding spring structures which can provide the desired spring functionality for mounting purposes. It becomes clear here that said sprung functionality is provided by way of the geometrical configuration of the spring structure, and recourse does not have to be made or at least does not have to be made exclusively to materials with correspondingly pronounced elastic properties of the main body. In particular, in the case of a bearing plate according to aspects of the invention, the entire main body, that is to say preferably at least the receiving section, the bearing section and the spring sections, will be configured from a non-elastomer component. Metallic materials, for example titanium, are preferred here.

The production of a bearing plate according to aspects of the invention is also inexpensive and simple, since said production can take place in a constructing manner, for example in an additive production method such as a 3D printing method.

By virtue of the fact that, in the case of a bearing plate according to aspects of the invention, the sprung functionality is then provided by way of a structural configuration of the spring structure of the spring sections, additional degrees of structural freedom can be utilized. The spring structure is configured for a sprung relative movability in the radial direction. Here, the orientation of the radial direction relates to the bearing axis of the bearing section. The spring sections or at least the spring structures of said spring sections also preferably extend in the radial direction. Here, the spring structures can be of regular or irregular configuration and can configure the desired functionality in a sprung way for said radial relative movability.

By virtue of the fact that the sprung relative movability has then been provided in the radial direction in a defined and specific way by way of the spring structures, a stabilizing action can occur in other directions, in particular in the desired axial direction. For example, as will be described later, this can be achieved by way of a continuous or substantially continuous cross section in said axial direction. The substantially free structural possibility of the spring structure then allows at least said two concepts of the present invention to be provided, that is to say a decoupling of the desired sprung relative movability in the radial direction and the simultaneously desired mechanical stabilization in the axial direction. This is possible particularly simply and inexpensively, the actual configuration of the spring structure being governed by the respective intended purpose.

A very wide variety of spring structures can thus provide a very wide variety of sprung relative movabilities. It is also insignificant in the present invention whether said sprung relative movability can or even should be of identical or else unequal or asymmetrical configuration in all directions.

As will likewise be described later, a bearing plate according to aspects of the invention can be used both alone and in combination with further bearing plates. The bearing plate can therefore already per se configure a bearing apparatus. It is conceivable, however, that two or more bearing plates are also combined to form a common bearing apparatus, in order for it to be possible for the desired bearing functionality to be configured with an enlarged embodiment form.

In the case of a bearing plate according to aspects of the invention, a considerable installation space reduction can be achieved in comparison with the known solutions, in particular in the axial direction. This is accompanied by a mechanical stabilization in said same axial direction. The reduction of installation space, in particular in the axial direction, allows firstly weight to be saved in the case of one structural embodiment of a chassis of a vehicle. Secondly, a greater structural freedom is produced, in particular concerning the adjoining components of the chassis bearing.

According to aspects of the invention, the number of spring sections is set at at least two. Depending on the suspension functionality and the necessary stabilization, however, a considerably higher number of spring sections will also be conceivable. Therefore, a number of spring structures or spring sections of approximately from 5 to 25 per main body is preferred. In this way, the individual spring sections configure as it were spring spokes which can be distributed symmetrically or asymmetrically around the bearing section.

It is to be noted, furthermore, that each spring section has at least one spring structure. It goes without saying that two or more spring structures per spring section can also be combined with one another. It is also insignificant whether the same spring structure is used multiple times within one spring section or else different spring structures have been combined with one another.

It can be advantageous if, in the case of a bearing plate according to aspects of the invention, the at least two spring sections are arranged symmetrically about the bearing section, in particular axially symmetrically about a bearing axis of the bearing section. As has already been explained initially, the spring sections can also be called spring spokes. A uniform or symmetrical distribution about the bearing section accordingly also entails a uniform or symmetrical bearing behavior for said bearing plate. In addition to a considerably simplified design of the desired spring functionality, the homogenization of the bearing behavior also leads to simpler production. By virtue of the fact that all the spring sections are oriented identically or substantially identically in the same and symmetrical direction, it is also the case that the quality control is simplified and there is an anti-rotation safeguard or a rotational freedom during the assembly.

It is likewise advantageous if, in the case of a bearing plate according to aspects of the invention, the at least two spring sections have identical or substantially identical spring structures. Said embodiment can be combined or is combined, in particular, with the symmetrical configuration in accordance with the preceding paragraph. The unity or a substantially existing unity between the spring sections also leads to a reduction of the necessary complexity in production and in design. In combination with the symmetrical or axially symmetrical configuration of the spring sections, this also leads to a particularly regular and uniform bearing behavior of the bearing plate.

Further advantages can be achieved if, in the case of a bearing plate according to aspects of the invention, the at least two spring sections, in particular the entire main body, have/has a continuous or substantially continuous cross section in the axial direction. This is to be understood to mean that the bearing plate or the main body is as it were an extruded body along the bearing axis. This also leads to a considerable reduction of the production complexity. A cross-sectional distribution of this type in a continuous way can entail advantages, in particular in the case of the use of additive or constructing production methods, such as a 3D printing method. It is also conceivable that the bearing plate is as it were cut or severed from an endless piece as a cross-sectional profile, with the result that the production can be of even simpler and less expensive configuration.

A further advantage can be achieved if, in the case of a bearing plate according to aspects of the invention, the main body has support sections for full-area support against corresponding support sections of main bodies of adjacent bearing plates. The support sections can have both a planar extent and curved or undercut embodiments. As will be described later, a combination of two or more bearing plates laterally next to one another can lead to a mechanical reinforcement of the entire bearing apparatus. In order to transfer the axial stabilizing action of the individual bearing plates to the bearing apparatus, the support sections serve to ensure said anti-tilt safeguard between the individual bearing plates. In this way, the mechanical stabilization of the entire bearing apparatus comprising two or more bearing plates is provided not only by way of the stabilizing action of the individual spring structures alone, but rather said stabilization is given further assistance by way of the mutual support of the adjoining bearing plates via the support sections. In the simplest way, this involves the full-area contact of planar support sections with one another. It goes without saying, however, that more complex embodiments are also conceivable which, in addition to a pure transmission of force, can also provide a force-fit connection frictionally locking connection and/or a positively locking connection between the adjoining support sections.

It can likewise be advantageous if, in the case of a bearing plate according to aspects of the invention, the at least two spring sections are arranged in an overlap-free manner with respect to one another. An overlap-free arrangement means that the spring sections do not cross or overlap in their extent between the receiving section and the bearing section. Each spring section has a defined beginning in the region of the bearing section and a defined end in the region of the receiving section. The spring section extends alone and in an overlap-free manner between said end and the beginning, to be precise along preferably the radial orientation of the main body. The intersection-free configuration of the spring sections leads to a further reduction of the complexity of the entire system and likewise to a homogenization of the bearing behavior.

Further advantages can be achieved if, in the case of a bearing plate according to aspects of the invention, the main body is configured in one piece with the bearing section, the receiving section and the at least two spring sections. This is conceivable, in particular, as a monolithic and/or integral configuration of the individual sections with the main body. The bearing plate is preferably a component which is configured completely in one piece, or monolithically and/or integrally. With reference to the production methods which have already been described with additive or constructing production possibilities, the advantages can be improved further here.

A bearing apparatus for a chassis bearing of a vehicle is likewise the subject matter of the present invention. A bearing apparatus of this type has at least two bearing plates in accordance with the present invention, which bearing plates are arranged with respect to one another so as to make contact and coaxially. Here, for the contact, in particular the coordination of the above-described support sections is provided for a full-area force support of the bearing plates next to one another. The use of at least two bearing plates according to aspects of the invention entails the same advantages for a bearing apparatus according to aspects of the invention as have been described in detail with reference to the bearing plates according to aspects of the invention. The mechanical stabilization and, in particular, the enlarging of the bearing apparatus by way of two or more bearing plates entails further improved advantages both with regard to the bearing forces which can be absorbed in the radial direction, and with regard to the anti-tilt safeguard.

It can be advantageous if, in the case of a bearing apparatus according to aspects of the invention, at least two bearing plates are of identical or substantially identical configuration. Here, the bearing plates are oriented, in particular, in an offset manner in the circumferential direction. The use of identical or substantially identical bearing plates further reduces the complexity of the bearing apparatus, the complexity of the production of the individual bearing plates, and, above all, the complexity of the assembly of the bearing apparatus. Attention thus no longer has to be paid here to which individual bearing plates have to be assembled, but rather there is a simple and, above all, low-risk assembly option. It is conceivable, in particular, that the bearing plates are arranged offset or rotated in the circumferential direction with respect to one another here. This is advantageous, in particular, if the individual bearing plates have a relatively low number of spring sections. In a similar manner to a bicycle rim, the individual spring spokes which are configured here as spring sections therefore overlap in the axial direction, such that a greater stabilizing action and/or a finer apportionment of the individual spring sections result/results in this viewing direction.

It is likewise advantageous if, in the case of a bearing apparatus according to aspects of the invention, at least two bearing plates are of different configuration, in particular have a different number and/or structure of the spring sections. It is to be noted here that it goes without saying that both identical bearing plates and different bearing plates can be combined in a common bearing apparatus. The structure or number and orientation of the individual spring sections is/are characteristic for the bearing behavior of the respective bearing plate. If different bearing plates are then used in a manner combined with one another in a common bearing apparatus, this leads to it being possible for different bearing behaviors of the entire bearing apparatuses to be achieved by way of the combination. Whereas, in the case of the known possible uses of bearing apparatuses, each bearing apparatus had to be designed and produced individually and for the respective intended use, a different bearing characteristic can now be combined with a small number of different bearing plates and provided by way of the combination of different bearing plates. In addition to a high flexibility in the provision of a very wide variety of bearing behaviors, a particularly simple configuration and a small number of individual bearing plates can provide said flexibility here.

### BRIEF DESCRIPTION OF THE DRAWING

Further advantages, features and details of the invention result from the following description, in which exemplary embodiments of the invention are described in detail with reference to the drawings. Here, the features which are mentioned in the claims and in the description may be essential to the invention in each case individually per se or in any desired combination. In the drawings, diagrammatically:

FIG. 1 shows one embodiment of a bearing plate according to aspects of the invention,

FIG. 2 shows the assembly situation of three bearing plates to form a bearing apparatus,

FIG. 3 shows a finally assembled bearing apparatus in accordance with the present invention.

### DETAILED DESCRIPTION OF THE INVENTION

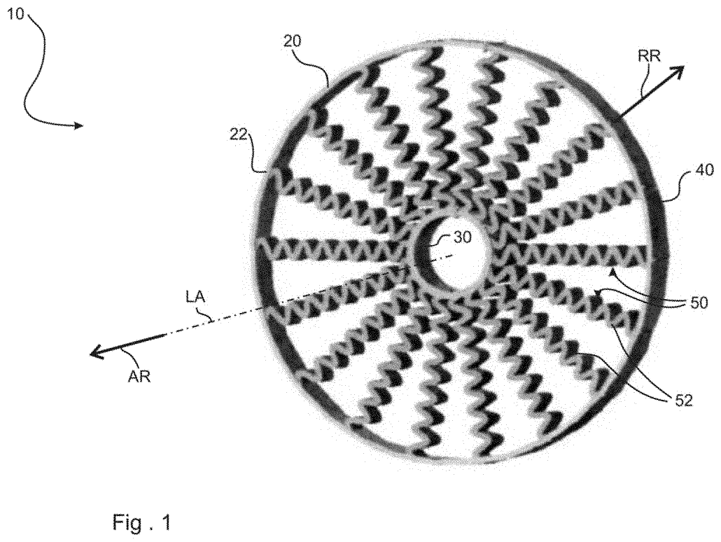

FIG. 1 shows how a bearing plate 10 can fundamentally be constructed. Here, it is equipped with a main body 20 made from a metal material, for example from titanium. In this embodiment, the production of said main body 20 or of the bearing plate 10 has taken place in an additive and constructing way, for example with the aid of a 3D printing method.

In order to provide the bearing functionality, a bearing section 30 can be seen as a round bearing opening in the center in the case of a bearing plate 10 according to FIG. 1. In this way, a bearing axis LA and therefore the axial direction AR are also defined. The bearing component to be received has a corresponding complementary bearing face for support against the bearing section 30.

In order for it then to be possible for the forces to be dissipated to the outside, the main 25 body 20 of the bearing plate 10 according to FIG. 1 is equipped with a receiving section 40 which is likewise configured here as a circumferential face. A transmission of force in the radial direction RR to the outside can then be provided by way of an insertion in a corresponding complementary receiving section of a chassis component, for example a link system. In order for it to be possible for a spring action to be provided during the 30 dissipation of the forces in the bearing plate 10, 18 spring sections 50 are therefore provided here. Here, the sprung action of the individual spring sections 50 is ensured by way of serpentine spring structures 52. As can be gathered clearly from FIG. 1, the individual spring sections 50 are oriented here next to one another and in a radial orientation along the radial direction RR, the spring sections 50 being arranged next to one another in an overlap-free manner.

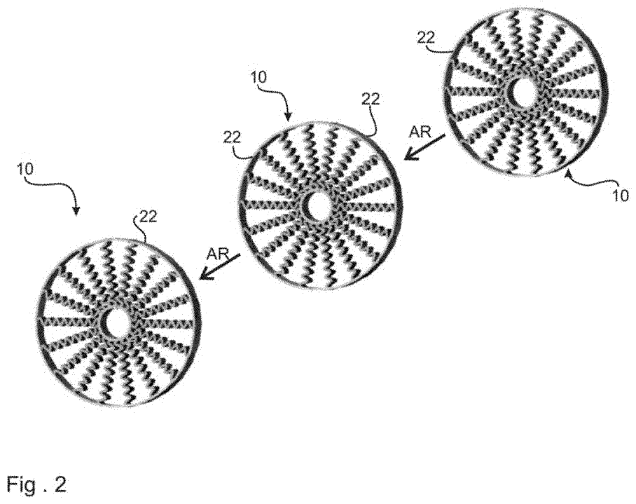

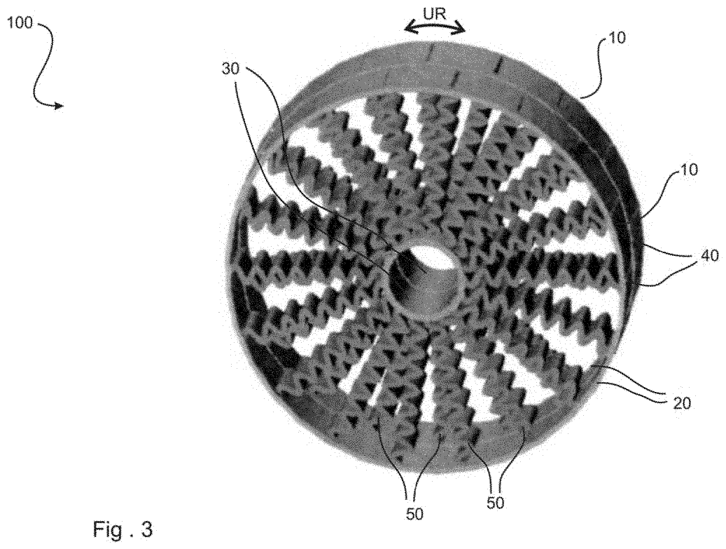

As can likewise be gathered from FIG. 1, the main body 20 has a continuous cross section along the bearing axis LA or along the axial direction AR. In this direction, the result is thus a wall which is perpendicular in a manner oriented in the axial direction AR, which wall makes the desired mechanical stabilization in said axial direction AR possible, that is to say against tilting of the individual elements with respect to one another.

Whereas a bearing plate 10 according to FIG. 1 can also fundamentally be used alone as a bearing apparatus, a combination of two or more bearing plates 10 is appropriate, in particular, for a bearing apparatus 100. A possible combination of this type is shown within the context of an assembly method according to FIG. 2. Here, along the axial direction AR, three bearing plates 10 are arranged against one another or are brought to lie with respect to one another with full-area contact and coaxially about the bearing axis AR. Here, the adjoining bearing plates 10 make contact in a full-area way with one another via the support sections 22. This results in a bearing apparatus 100, as shown by FIG. 3, for example.

FIG. 3 consists of two separate bearing plates 10 which have been joined together in a similar way, as shown by FIG. 2. Here, however, an additional improvement has occurred, namely an offset in the circumferential direction UR of the two bearing plates 10 with respect to one another. This can be seen, in particular, in the fact that the symmetrically arranged spring sections 50 of the two adjoining bearing plates 10 then do not overlap in the axial direction AR, but rather a greater number of spring sections 50 become visible as a result of the rotation along the circumferential direction UR of the two bearing plates 10 with respect to one another. This fragmentation of the free sections leads to a further mechanical stabilization on the basis of a particularly simple construction of the individual bearing plates 10 per se. Therefore, a more complex bearing functionality for the entire bearing apparatus 100 can be built up from individual bearing plates 10 which are as simple as possible.

The above explanation of the embodiments describes the present invention exclusively within the context of examples. It goes without saying that individual features of the embodiments, if technically appropriate, can be combined freely with one another, without departing from the scope of the present invention.

What is claimed is:

1. A bearing plate or a chassis bearing of a vehicle, said bearing plate comprising:
a main body with a bearing section or making full-area contact with a complementary bearing face of a component to be mounted, and
a receiving section for being received in a force-transmitting manner on a complementary receiving section of a chassis component,
said bearing section being connected to the receiving section via at least two spring sections which have a spring structure for relative movability in a radial direction and a stabilization in an axial direction.

2. The bearing plate as claimed in claim 1, wherein the at least two spring sections are arranged axially symmetrical about a bearing axis of the bearing section.

3. The bearing plate as claimed in claim 1, wherein the at least two spring sections have identical or substantially identical spring structures.

4. The bearing plate s claimed in claim 1, wherein the at least two spring sections and the entire main body have a continuous or substantially continuous cross section in the axial direction.

5. The bearing plate as claimed in claim 1, wherein the main body has support sections for full-area support against corresponding support sections of main bodies of adjacent bearing plates.

6. The bearing plate as claimed in claim 1, wherein the at least two spring sections are arranged in an overlap-free manner with respect to one another.

7. The bearing plate as claimed in claim 1, wherein the main body is configured in one piece with the bearing section, the receiving section and the at least two spring sections.

8. A bearing apparatus for a chassis bearing of a vehicle, having at least two of the bearing plates of claim 1, which bearing plates are arranged with respect to one another so as to make coaxial contact.

9. The bearing apparatus s claimed in claim 8, wherein the at least two bearing plates are of identical or substantially identical configuration, and the bearing plates are oriented in an offset manner in a circumferential direction.

10. The bearing apparatus as claimed in claim 8, wherein at least two bearing plates have a different number or structure of spring sections.
